(19) United States
(12) Patent Application Publication
(10) Pub. No.: US 2026/0058472 A1
(43) Pub. Date: Feb. 26, 2026

(54) WAVE ENERGY POWER GENERATION AND FLYWHEEL ENERGY STORAGE INTEGRATION SYSTEM AND METHOD THEREOF

(71) Applicant: National Cheng Kung University, Tainan City (TW)

(72) Inventors: TING-CHIA OU, Tainan City (TW); YU-TUNG CHEN, Tainan City (TW); ZHI-CHIN JU, Tainan City (TW)

(21) Appl. No.: 19/302,429

(22) Filed: Aug. 18, 2025

(30) Foreign Application Priority Data
Aug. 19, 2024 (TW) 113131168

(51) Int. Cl. H02J 3/30

(52) U.S. Cl. CPC H02J 3/30; H02J 2300/20

(57) ABSTRACT

Provided includes: a wave energy power generation device; a flywheel energy storage device; a flywheel state-of-charge calculation module; and an energy management module, and when the wave energy power generation device is in the power generation cycle, the power of the electric energy does not meet the grid power specification of the power grid, and the flywheel energy storage device is in an energy-available state, and when the wave energy power generation device is not in the power generation cycle and the flywheel energy storage device When in this energy-available state, the flywheel energy storage device can be controlled to release the flywheel rotational kinetic energy to compensate for the output power to achieve stable power supply to the power grid.

### CROSS-REFERENCE TO RELATED APPLICATION

This application claims the benefit of Taiwan Patent Application No. 113131168, filed on Aug. 19, 2024, which is hereby incorporated by reference for all purposes as if fully set forth herein.

### TECHNICAL FIELD

Disclosed is an energy integration system, and in particular an energy integration system integrating wave energy generation and flywheel energy storage.

### BACKGROUND

In recent years, sustainability issues have gained significant attention, and wave energy is one of the emerging energy with a development potential. The wave energy has advantages of high energy density, predictability, low environmental impact, diverse operation modes, and a coastal protection effect, and the theoretical energy capture efficiency for the wave energy is higher than that for other renewable energy. Moreover, there are a wide variety of waves, and accordingly, wave energy conversion devices based on different structural principles, such as a point absorber wave energy conversion device, an oscillating wave surge conversion device, and an oscillating-water-column wave energy conversion device, have developed according to different energy collection manners. However, due to the influence of daily and seasonal weather variations on waves and an inherent characteristic of the waves, i.e., having irregular and fluctuating frequencies, intermittent power output occurs in the process of converting wave energy into electrical energy and outputting same to a grid for utilization.

### SUMMARY

Disclosed is a wave energy generation and flywheel energy storage integration system, comprising a wave energy generation device, which is configured to convert wave energy into electrical energy in a power generation cycle, and supply the electrical energy to a grid; a flywheel energy storage device, which is configured to store rotational kinetic energy of a flywheel; a flywheel state-of-charge calculation module, which is configured to calculate the rotational kinetic energy of the flywheel to obtain a calculation result; and an energy management module, which is configured to determine whether the flywheel energy storage device is in a fully charged state and in an energizable state according to the calculation result, when the wave energy generation device is in the power generation cycle, power of the electrical energy does not satisfy grid specification power of the grid and the flywheel energy storage device is in the energizable state, control the flywheel energy storage device to release the rotational kinetic energy of the flywheel for compensating and outputting power, so as to stably supply power to the grid, and when the flywheel energy storage device is not in the energizable state, calculate a loss of power supply probability of the wave energy generation and flywheel energy storage integration system.

In an embodiment, when the wave energy generation device is in the power generation cycle, the power exceeds the grid specification power and the flywheel energy storage device is not in the fully charged state, the energy management module controls the flywheel energy storage device to receive a remaining part of power of the electrical energy to charge the flywheel energy storage device, so as to increase the rotational kinetic energy of the flywheel.

In an embodiment, when the wave energy generation device is not in the power generation cycle and the flywheel energy storage device is in the energizable state, the energy management module is further configured to control the flywheel energy storage device release the rotational kinetic energy of the flywheel, so as to continuously output power to stably supply power to the grid.

In an embodiment, the wave energy generation device comprises: a wave energy collection unit, which is configured to collect wave energy, wherein the wave energy collection unit comprises a channel, which is built by two adjacent guide walls, has a wave inlet and a wave outlet, and has a collection angle, and the magnitude of wave energy which is collected by the wave energy collection unit is adjusted according to the length of the two guide walls and the collection angle.

In an embodiment, the two guide walls are made of a carbon-negative material.

In addition, the present disclosure further provides a wave energy generation and flywheel energy storage integration method, comprising: converting, by means of a wave energy generation device, wave energy into electrical energy in a power generation cycle, and supplying the electrical energy to a grid; storing rotational kinetic energy of a flywheel by means of a flywheel energy storage device; calculating the rotational kinetic energy of the flywheel to obtain a calculation result; determining, according to the calculation result, whether a flywheel energy storage device is in a fully charged state and in an energizable state; when the wave energy generation device is in the power generation cycle, power of the electrical energy does not satisfy grid specification power of the grid and the flywheel energy storage device is in the energizable state, controlling the flywheel energy storage device to release the rotational kinetic energy of the flywheel for compensating and outputting power, so as to stably supply power to the grid; and when the flywheel energy storage device is not in the energizable state, calculating a loss of power supply probability of a wave energy generation and flywheel energy storage integration system composed of the wave energy generation device and the flywheel energy storage device.

In an embodiment, when the wave energy generation device is in the power generation cycle, the power exceeds the grid specification power and the flywheel energy storage device is not in the fully charged state, the energy management module controls the flywheel energy storage device to receive a remaining part of power of the electrical energy to charge the flywheel energy storage device, so as to increase the rotational kinetic energy of the flywheel.

In an embodiment, when the wave energy generation device is not in the power generation cycle and the flywheel energy storage device is in the energizable state, the energy management module is further configured to control the flywheel energy storage device release the rotational kinetic energy of the flywheel, so as to continuously output power to stably supply power to the grid.

In an embodiment, the wave energy generation and flywheel energy storage integration method further comprises: adjusting the magnitude of wave energy which is collected by the wave energy collection unit using the length of two adjacent guide walls which form a channel of the wave energy collection unit in the wave energy generation device, and a collection angle of the channel.

In an embodiment, the wave energy and flywheel energy storage integration method further comprises: performing carbon capture and carbon curing using a carbon-negative material which is contained in the two guide walls.

### BRIEF DESCRIPTION OF THE DRAWINGS

To more comprehensively understand embodiments and advantages thereof, the description below is provided in conjunction with the accompanying drawings, in which:

FIG. 1 is a block diagram of a wave energy generation and flywheel energy storage integration system according to an embodiment of the present disclosure;

FIG. 2 is a top view diagram of a wave energy generation device according to an embodiment of the present disclosure;

FIG. 3 is a block diagram of a flywheel energy storage device according to an embodiment of the present disclosure;

FIG. 4 is a block diagram of a flywheel control module according to an embodiment of the present disclosure;

FIG. 5 is a block diagram of the control performed by a flywheel control module according to an embodiment of the present disclosure;

FIG. 6 is a flowchart of the mode control performed by an energy management module according to an embodiment of the present disclosure;

FIG. 7 is a schematic diagram of the operation of a wave energy generation and flywheel energy storage integration system according to an embodiment of the present disclosure in different modes;

FIG. 8 is a block diagram of the integration control performed by a wave energy generation and flywheel energy storage integration system according to an embodiment of the present disclosure; and

FIG. 9 is a schematic diagram of a comparison of output power of a wave energy generation device and output power of a wave energy generation device integrated with a flywheel energy storage device according to an embodiment of the present disclosure.

### DETAILED DESCRIPTION

Embodiments of the present disclosure will be discussed in detail below. However, it should be understood that the embodiments provide many applicable concepts that can be implemented in a wide variety of specific context, and the discussed and disclosed embodiments are provided only for illustrative purposes and are not intended to limit the scope of the present disclosure.

A flywheel energy storage system (FESS) is an energy storage means that converts electrical energy into rotational kinetic energy of a flywheel for storage and may convert the rotational kinetic energy into electrical energy for release when necessary. In the present disclosure, the FESS is integrated with wave energy generation to form a wave energy generation and flywheel energy storage integration system, so as to assist in adjusting a wave energy generation device, thereby stably supplying power which conforms to the specification of a power demander. In addition, the terms of “power generation” and “discharge” of a wave energy generation device 111 in the present disclosure refer to the case that the wave energy generation device 111 converts wave energy into electrical energy and transmits same to the outside. The term of “charge” of a flywheel energy storage device 112 refers to the case that the flywheel energy storage device 112 converts electrical energy into the form of rotational kinetic energy of a flywheel for storage. The term of “discharge” of the flywheel energy storage device 112 refers to the case that the flywheel energy storage device 112 converts the rotational kinetic energy of the flywheel into electrical energy and transmits same to the outside.

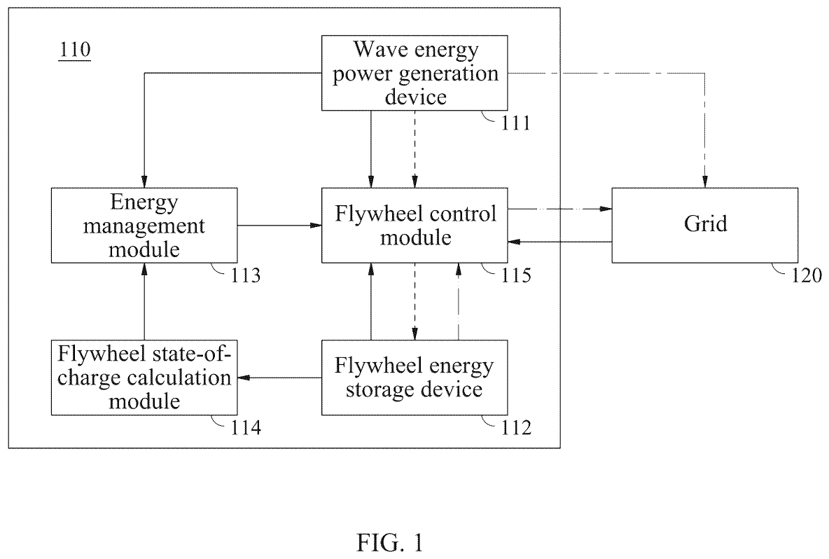

FIG. 1 is a block diagram of a wave energy generation and flywheel energy storage integration system 110 according to an embodiment of the present disclosure. The wave energy generation and flywheel energy storage integration system 110 includes a wave energy generation device 111, a flywheel energy storage device 112, an energy management module 113, a flywheel state-of-charge calculation module 114 and a flywheel control module 115. The wave energy generation device 111 is suitable for being arranged on a shore, and may convert wave energy of sea wave impacts into electrical energy and supply same to a grid 120 (as indicated by a dash-dot arrow in FIG. 1). Since power which is supplied to the grid 120 needs to satisfy grid specification power (e.g., agreed power supply power negotiated with a power demander), if power supplied by the wave energy generation device 111 is sufficient to satisfy the grid specification power, remaining electrical energy may be transmitted to the flywheel energy storage device 112 for storage (as indicated by dashed arrows in FIG. 1). Otherwise, if the flywheel energy storage device 112 has been in a fully charged state, the remaining electrical energy which cannot be stored in the flywheel energy storage device 112 is further used for other uses, such as hydrogen production.

Upon receiving electrical energy transmitted from the wave energy generation device 111, the flywheel energy storage device 112 converts the electrical energy into rotational kinetic energy of a flywheel for storage. The stored rotational kinetic energy of the flywheel is retained in such a way that, when the power supplied by the wave energy generation device 111 fails to satisfy the grid specification power of the grid 120, subsequently, the flywheel energy storage device 112 may convert the rotational kinetic energy into electrical energy for release. The released electrical energy, together with the electrical energy from the wave energy generation device 111, is then jointly supplied to the grid 120 (as indicated by the dash-double-dot arrow in FIG. 1), thereby assisting in enabling total output power of the wave energy generation and flywheel energy storage integration system 110 to meet requirements of the grid 120. Moreover, when the wave energy generation device 111 is not generating power, the flywheel energy storage device 112 may convert the rotational kinetic energy of the flywheel into electrical energy and transmit the electrical energy to the grid 120, such that the flywheel energy storage device 112 independently enables the power supplied by the wave energy generation and flywheel energy storage integration system 110 to satisfy the grid specification power.

The switching of a power mode of the wave energy generation and flywheel energy storage integration system 110 is controlled by the energy management module 113 (as indicated by the solid arrows in FIG. 1). The energy management module 113 receives a power generation state of the wave energy generation device 111 and receives, by means of the flywheel state-of-charge calculation module 114, a state of charge (SOC) of the flywheel energy storage device 112 that is calculated by the flywheel state-of-charge calculation module, so as to determine and control, according to whether the wave energy generation device 111 is currently generating power, whether the supplied power conforms to the grid specification power of the grid 120, and the SOC of the flywheel energy storage device 112, the flywheel energy storage device 112 to be charged or discharge. The energy management module then transmits a control signal to the flywheel control module 115 to control electrical energy into and out of the flywheel energy storage device 112. In addition to receiving the control signal from the energy management module 113, the flywheel control module 115 also receives a voltage from the wave energy generation device 111 and the grid 120, and any signal from the flywheel energy storage device 112 that may be used for controlling the flywheel energy storage device 112, such as a current and a rotation speed, so as to control the rotation speed of a flywheel in the flywheel energy storage device 112, or discharge power thereof, etc., thereby enabling the stable transmission of the electrical energy of the wave energy generation and flywheel energy storage integration system 110.

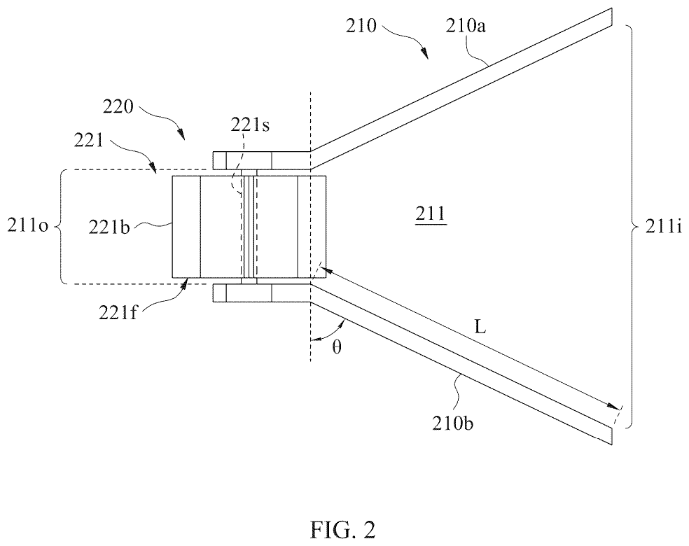

FIG. 2 is a top view diagram of the structure of a wave energy generation device 111 according to an embodiment of the present disclosure. The wave energy generation device 111 includes a wave energy collection unit 210 and a wave energy power generator set 220. The wave energy collection unit 210 includes a channel 221, which is built by two adjacent guide walls 210a and 210b, the channel 221 has a wave inlet 211i and a wave outlet 211o, and the wave inlet 211i has a diameter greater than that of the wave outlet 211o and tapers towards the wave outlet 211o in an inverted V-shape. The wave energy power generator set 220 is located at the wave outlet 211o, spans across the adjacent guide walls 210a and 210b, and includes a water turbine 221. The water turbine 221 includes an impeller 221f and a rotary shaft 221s, which is perpendicular to a wave outlet direction of the channel 211, and the immersion depth of the impeller 211f may be ¼ to ⅓ of the length of a blade 211f. When waves enter through the wave inlet 211i and flow towards the wave outlet 211o, the waves impact the impeller 211f, so as to rotate the rotary shaft 221s, such that the wave energy power generator set 220 converts wave energy into electrical energy to supply power. The tapered profile of the channel 211 may reduce an impact force of the waves onto the impeller 221b, so as to prolong the service life of the impeller 221b, and can also increase the water level of the waves to increase the contact area between the waves and the impeller 221b, such that the waves more efficiently drive the rotation of the impeller 221b. In addition, the rotary shaft 221s perpendicular to the wave outlet direction may improve the power generation efficiency. Regarding the adjustment of the structure of the wave energy generation device 111, the amount of collected wave energy may be increased by means of increasing the guide wall length of the guide walls 210a and 210b of the channel 211 and/or decreasing a collection angle θ of the channel 221, whereby generation power of the wave energy generation device 111 can be further increased and a loss of power supply probability of the wave energy generation and flywheel energy storage integration system 110 can be reduced.

Moreover, in addition to generating the green power, the wave energy generation device 111 may replace general cement with carbon-negative cement to be the material of the guide walls 210a and 210b. The carbon-negative cement is a kind of cement that can capture and sequestrate carbon dioxide, with the amount of captured and sequestrated carbon dioxide being greater than the amount of carbon emission during the production thereof. The cement may be made of, for example, seawater-based magnesium or olivine, which has a carbon capture effect. Moreover, in addition to replacing wave-dissipating blocks as a wave-dissipating structure for seawalls with their wave-impact resistance capability, the guide walls 210a and 210b constructed with the carbon-negative cement can significantly increase the amount of cured carbon and facilitate the formation of a carbon sink. In addition, such wave energy generation device 111 also has potential for marine ecological restoration. Nearshore species, such as microalgae and seagrass, which are high carbon-sequestration species, are provided on the guide walls 210a and 210b for propagation, so as to further improve the carbon capture capability of the guide walls 210a and 210b. That is, the guide walls 210a and 210b may use the carbon-negative material thereof as green infrastructure to perform carbon capture and carbon curing in the sea, so as to increase blue carbon sink benefits, and exert positive influence on local ecological diversity. Moreover, such wave energy generation device 111 made of the carbon-negative material requires only partial recycling of metal and plastics after decommissioning. The guide walls 210a and 210b, due to low ecological disruption from the material thereof, can be retained on the shore as a substrate for artificial reefs, becoming a part of natural habitats. In other words, the wave energy generation device 111 exhibits minimal environmental impact throughout its full lifecycle and demonstrates significant contributions to sustainable development.

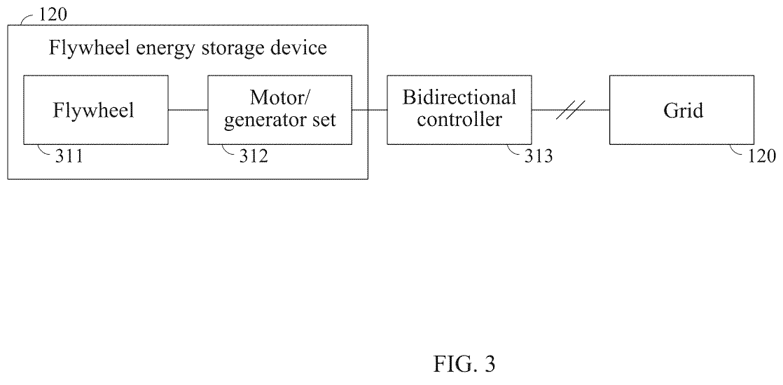

FIG. 3 is a block diagram of a flywheel energy storage device 112 according to an embodiment of the present disclosure. During charging, the flywheel energy storage device 112 drives a motor/generator set 312 with electrical energy to rotate a flywheel 311, so as to convert the electrical energy into the form of rotational kinetic energy of the flywheel for storage. During discharging, the motor/generator set 312 controls the rotation of the flywheel 311, so as to convert the rotational kinetic energy of the flywheel into the electrical energy for release. The charging and discharging of the flywheel energy storage device 112 are performed by means of mutual conversion between the electrical energy and the rotational kinetic energy of the flywheel. Due to the influence of daily and seasonal weather variations on waves and inherent irregular and fluctuating frequencies and amplitudes of the waves, intermittent power output occurs in the process of converting wave energy into electrical energy and outputting same to the grid 120 for utilization. Accordingly, the wave energy generation device 111 requires coordinated operation with the flywheel energy storage device 112 to stably transmit power which meets requirements to the grid 120.

As shown in FIG. 3, the flywheel energy storage device 112 includes the flywheel 311 and the motor/generator set 312, the flywheel 311 including a rotator and a rotator bearing. The flywheel energy storage device 112 may also be connected to a bidirectional controller 313 for the control over the charging and discharging of the flywheel energy storage device 112. The rotator of the flywheel is the key for energy storage in the flywheel energy storage device 112. In an embodiment, a cylindrical rotator made of steel is selected to be the rotator of the flywheel. However, the material and shape of the rotator of the flywheel are not limited these. For example, the material may also be an aluminum alloy, a titanium alloy, fiberglass, carbon fiber, etc., and the shape may also be a fusiform shape, a constant stress disc, etc.

The bearing of the flywheel energy storage device 112 is used for supporting to fix the position of a shaft and ensure the smooth operation of the flywheel energy storage device 112, and reducing energy loss by means of reducing friction between bearing components. In an embodiment, an active magnetic bearing is selected to be the bearing of the flywheel energy storage device 112. Magnetic bearings are non-contact bearings which are not prone to consuming a large amount of energy due to friction in the case of high speed rotation. The active magnetic bearing among the magnetic bearings has the flexibility to perform active control. Moreover, the active magnetic bearing may be a three-axis radial magnetic bearing that is formed by three electromagnets and driven by an inverter. The structure is relatively simple, the volume of the bearing may be reduced, and the remagnetization frequency is low. Compared to a common four-axis bearing, the cost, power consumption and iron loss are lower, and the heat dissipation performance is better. However, the type, axis quantity and driving mode of the bearing are not limited to these.

The motor/generator set 312 is used for performing charging or discharging in cooperation with the flywheel 311 in the flywheel energy storage device 112. When the flywheel energy storage device 112 is being charged, the motor/generator set uses received electrical energy (e.g., electrical energy supplied by the wave energy generation device 111) to drive the rotation of the flywheel 311, and converts the electrical energy into rotational kinetic energy of the flywheel for storage. During discharge, the flywheel 311 is controlled to rotate, the rotational kinetic energy of the flywheel is converted into electrical energy which conforms to target power, and the electrical energy is supplied to the grid 120. In an embodiment, a permanent magnet motor/generator set is selected to be the motor/generator set 312 of the flywheel energy storage device 112. The permanent magnet motor/generator set is low in activation loss, high in efficiency and power density, small in volume and easy in heat dissipation, and has advantages of not using a permanent magnet and the controllability being high. However, the motor/generator set 312 may also be an induction motor, a synchronous variable reluctance motor, etc., and the used types are not limited to these.

The provision of the bidirectional controller 313 is a design for a motor/generator in consideration of energy conversion thereof. Since power which is generated by the wave energy generation device 111 and is about to be stored in the flywheel energy storage device 112, and power which is output by the flywheel energy storage device 112 and is about to be transmitted in grid connection with the wave energy generation device 111 are both alternating currents, and such power needs refined power control, it is necessary to perform bidirectional power conversion which can be finely controlled. The bidirectional controller 313 may be an alternating current-alternating current (AC-AC) bidirectional controller or an alternating current-direct current-alternating current (AC-DC-AC) bidirectional controller, however, the types of bidirectional controller are not limited to these.

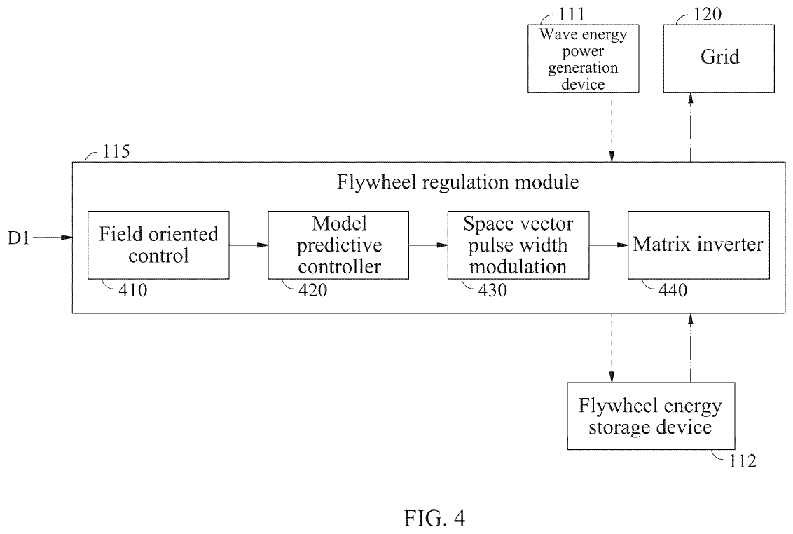

FIG. 4 is a block diagram of a flywheel control module 115 according to an embodiment of the present disclosure. The flywheel control module 115 controls the flywheel energy storage device 112 using the principle of field oriented control (FOC) in conjunction with model predictive control (MPC), space vector pulse width modulation (SVPWM) and a matrix inverter (MI). As shown in FIG. 4, the flywheel control module 115 may receive a control signal D1, the control signal D1 including a signal for mode control of the flywheel energy storage device 112, and any signal that may be used for controlling the flywheel energy storage device 112, such as a voltage state and a current state of the wave energy generation device 111 and the grid 120, and may control the motor/generator set 312 of the flywheel energy storage device 112 by means of predicting a future behavior of a controlled variable and processing and converting the control signal D1, such that the flywheel energy storage device 112 can be stably charged with electrical energy from the wave energy generation device 111 (as indicated by the dashed arrow in FIG. 4) and stably discharge to the grid 120 with electrical energy which is generated by means of conversion by the flywheel energy storage device 112 (as indicated by the dash-double-dot arrow in FIG. 4).

A field oriented control 410 controls the operation of the flywheel energy storage device 112 by means of controlling the rotator rotation speed and torque of a motor/generator. After direct axis-quadrature axis (d-axis-q-axis) coordinate system conversion (hereinafter referred to as dq coordinate system conversion) is performed, a magnetic field of a stator is decomposed into a stator current on a d-axis and a stator current on a q-axis, which may be separately controlled, and the magnetic flux and torque of the rotator may thus be controlled. The field oriented control 410 has the advantages of being capable of efficiently controlling a permanent magnet motor/generator with high performance and effectively suppressing the fluctuation of the speed and torque of the rotator. In an embodiment, the field oriented control 410 cooperates with a power controller, such as a proportional-integral (PI) controller, to control parameters of the motor/generator, adjusting a deviation between an actual output value and a set value (e.g., a deviation between an actual current of the motor/generator and a set value and between an actual rotation speed thereof and a set value) in a PI manner, and thus generating a reference voltage or a reference current. In addition, a control signal represented by a dq coordinate system may be subsequently modulated and converted into a control signal represented by an abc coordinate system.

A model predictive control 420 is an improved control method for a power system, where different target objectives, system constraints and current states are incorporated in a cost function, so as to predict a future behavior of a controlled variable to determine an optimal control signal combination at a future time point. The model predictive control 420 has the advantages of being easy to understand and implement, having high flexibility, and being capable of controlling a plurality of output variables at the same time so as to support multiple control objectives. Accordingly, the architecture of the flywheel control module 115 may use the model predictive control 420, such that the grid 120 has the elasticity against the fluctuation of power, and the resilience of the grid is improved. In an embodiment, the model predictive control 420 may calculate a future behavior of a controlled variable using data of the system in the current state, such as voltage and current, set reference values (e.g., a reference voltage and a reference current), an optimization function, etc., and generate an optimized control signal, for example, a signal for controlling switch combinations of a matrix inverter 440.

A space vector pulse width modulation 430 is used for modulating the control signal which is generated by the model predictive control 420 and represented by the dq coordinate system into a pulse width modulated signal in the abc coordinate system that is required by the matrix inverter 440, and has the advantages of the voltage utilization rate being high, reducing current harmonic waves and switching loss, etc. The modulation methods are not limited to these, and may also include space vector modulation (SVM), sinusoidal pulse width modulation (SPWM), etc.

The matrix inverter 440 has a plurality of switches to adjust voltage and current using three-phase current balance, and has the advantages of having a bidirectional power flow, an input power factor being controllable, the volume being small, the switching efficiency being high and the maintenance cost being low, so as to be suitable for the use in a system with a limited volume. In an embodiment, the used matrix inverter 440 may be used for replacing an inverter set. The relationship between input voltage and output voltage of the matrix inverter 440 and the relationship between input current and output current of the matrix inverter are as shown by equation (1) and equation (2):

$$[ {V}^{a b c} ] = S [ {v}^{a b c} ] , \qquad ( l )$$

$$and$$

$$[ {i}^{a b c} ] = {S}^{T} [ {I}^{a b c} ] , \qquad ( 2 )$$

V^{abc} and i^{abc} are input voltage and input current, and v^{abc} and I^{abc} are output voltage and output current. S is a switch matrix, and S^{T} is a transposed matrix of the switch matrix. A switch state element in the matrix may be 0 or 1 according to whether the corresponding switch is switched on or off. The limitations of avoiding input short-circuits and output open-circuits must be taken into consideration. Accordingly, there are a total of 27 types of valid switch combinations in the embodiment.

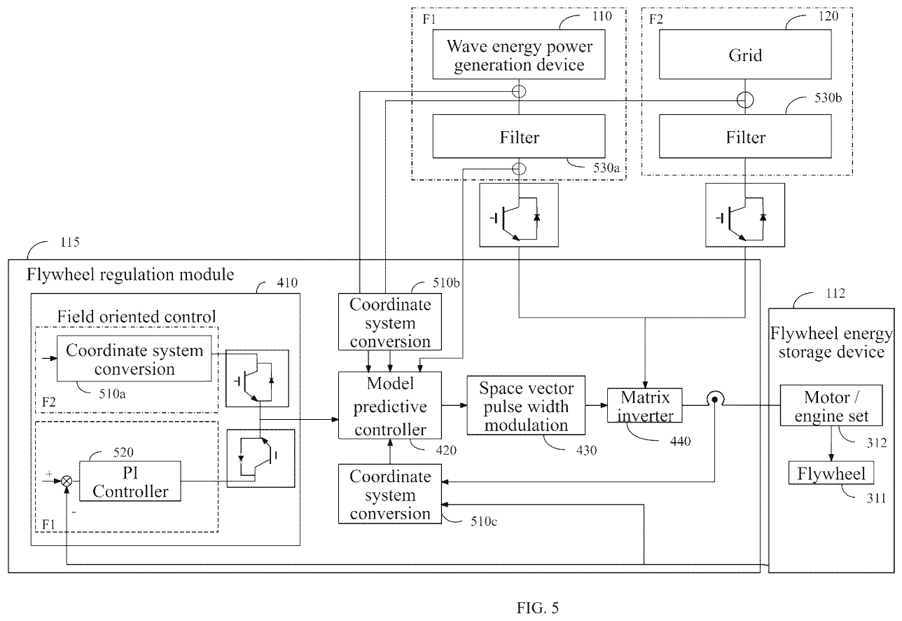

FIG. 5 is a block diagram of the control performed by a flywheel control module 115 according to an embodiment of the present disclosure. Box F1 denotes the state in which the flywheel energy storage device 112 is charged with electrical energy supplied by the wave energy generation device 111. Box F2 denotes the state in which the flywheel energy storage device 112 discharges released electrical energy to the grid 120.

In a charge mode of the wave energy generation and flywheel energy storage integration system 110, the control objective of the flywheel control module 115 is to adjust the rotation speed of the flywheel 311, generate a reference stator current

$$( {i}_{q}^{*} )$$

of the motor/generator set 312 by means of the PI controller 520 according to a reference angular velocity ω*ₘ provided by an external control circuit, e.g., the energy management module 113, and the current angular velocity ω, and then calculate and generate a control signal for an optimal switch combination of the matrix inverter 440 by means of the model predictive control 420 according to voltages (V_{w_a′}, V_{w_b′}, V_{w_c} are converted into V_{w_d}, V_{w_q}) of the wave energy generation device 111 that has been converted by means of a coordinate system conversion 510b, voltages (Vₐ, V_{b}, V_{c}) after a filter 530a, and the current stator current (converted into i_{d}, i_{q} according to iₐ, i_{b}, i_{c} and a rotator angle θ) of the motor/generator set 312 that has been converted by means of a coordinate system conversion 510c. The coordinate system conversion represents converting a three-phase (abc) alternating current system into a two-phase (dq) system, so as to more easily and efficiently control the stator current.

Afterwards, the control signal is converted into a pulse width modulated signal by means of the space vector pulse width modulation 430, and then transmitted to the matrix inverter 440, so as to convert power transmitted from the wave energy generation device 111 and control the operation of the motor/generator set 312, thereby increasing the rotation speed of the flywheel energy storage device 112. At this time, electrical energy is converted into rotational kinetic energy of the flywheel of the flywheel energy storage device 112, and the rotation speed of the flywheel 311 and the SOC are increased.

Similarly, in a discharge mode of the wave energy generation and flywheel energy storage integration system 110, the control objective of the flywheel control module 115 is to enable the flywheel energy storage device 112 to supply power that is sufficient to satisfy the grid specification power of the grid 120. An expected grid voltage V_{g ref} is converted into V_{g_d ref} through a coordinate system conversion 510a, and is transmitted to the model predictive control 420 together with i_{d}, i_{q} and the current grid voltage (V_{g_a}, V_{g_b}, V_{g_c} are converted into V_{g_d}, V_{g_q}) that has been converted by means of the coordinate system conversion 510b. The model predictive control 420 performs calculation and prediction using the received voltages, etc., and generates a control signal for the matrix inverter 440. The control signal is used for controlling the matrix inverter 440 after being converted into a pulse width modulated signal by means of the space vector pulse width modulation 430, so as to drive the discharge of the flywheel energy storage device 112 and control the motor/generator set 312 to output power which meets requirements of the grid 120 to the grid 120.

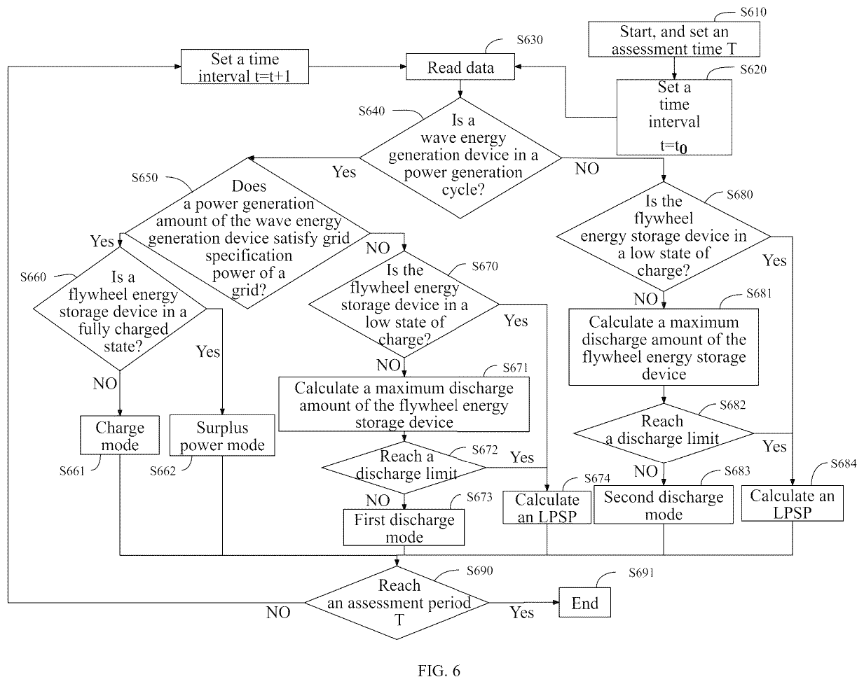

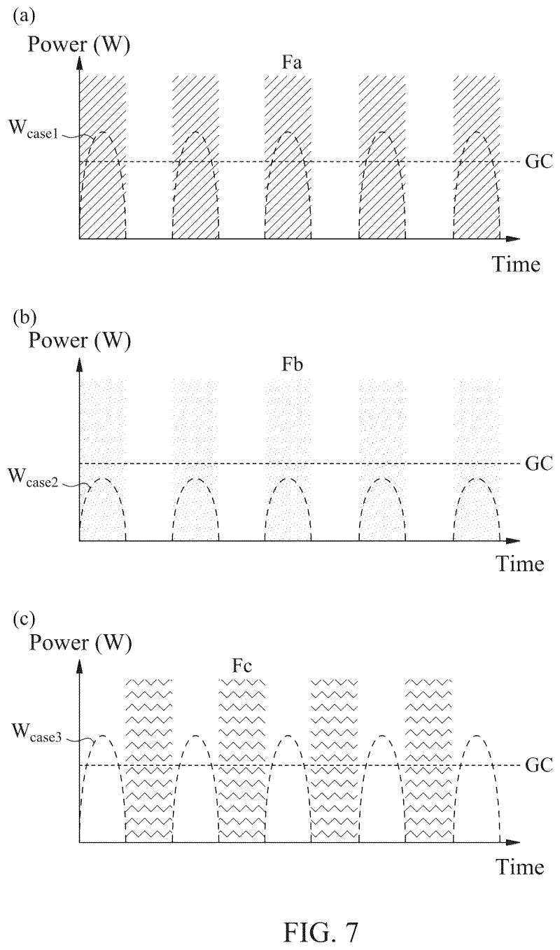

FIG. 6 is a flowchart of the mode control performed by an energy management module 113 according to an embodiment of the present disclosure. FIG. 7 is a schematic diagram of the operation of a wave energy generation and flywheel energy storage integration system 110 according to an embodiment of the present disclosure in different modes. W_{case 1} [symbol] W_{case 2} [symbol] W_{case 3} represent output power of the wave energy generation device 111 in a time interval, and the horizontal dashed line GC refers to the grid specification power of the grid 120. In FIG. 7(a), the hatched parts represent time bands Fa during which the flywheel energy storage device 112 operates in the charge mode; in FIG. 7(b), the dotted parts represent time bands Fb during which the flywheel energy storage device 112 operates in a first discharge mode; and in FIG. 7(c), the zigzag-patterned parts represent time bands Fc during which the flywheel energy storage device 112 operates in a second discharge mode.

The energy management module 113 of the wave energy generation and flywheel energy storage integration system 110 executes the determination flow as shown in FIG. 6. According to the power generation state of the wave energy generation device 111, when a power generation amount of the wave energy generation device 111 exceeds the requirement of the grid 120, the flywheel energy storage device 112 is controlled to operate in the charge mode for power storage (as shown in FIG. 7(a)), and when wave energy does not generate power or power transmitted to the grid 120 is insufficient (e.g., wave recession, insufficient wave or absence of wave), the flywheel energy storage device 112 is controlled to operate in the discharge mode to assist with power stored therein (e.g., as in FIG. 7(b) and FIG. 7(c), such that the continuous and stable power generation throughout the full lifecycle of the wave energy generation and flywheel energy storage integration system 110 is achieved. The detailed flow will be illustrated below.

Starting from step S610, an assessment period T is set. At step S620, a time interval t is set to be to. According to observation requirements, the evaluation period T can be set to be, for example, one week, one month, one quarter, or one year. The time interval t may be set according to power generation frequency of the wave energy generation device 111, for example, setting the duration of one power generation cycle as the time interval t, but the setting of time is not limited to these. Next, at step 630, the energy management module 113 reads a received power generation state of the wave energy generation device 111. At step S640, whether the wave energy generation device 111 is generating power is determined. If regarding generation power of the wave energy generation device 111, P_{w}≠0, this represents that the wave energy generation device 111 is currently in the power generation cycle, and if the generation power P_{w}=0, this represents that the wave energy generation device 111 is not in the power generation cycle.

When it is determined that the wave energy generation device 111 is in the power generation cycle, whether the generation power P_{w} satisfies grid specification power P_{gc} is further determined at step S650. As shown in FIG. 7(a), if P_{w}>P_{gc}, this indicates that the wave energy generation device 111 can satisfy the supply to the grid 120, even having surplus power that can be stored or used. Power P_{cur} of the surplus power is as shown by equation (3):

$${P}_{c u r} ( t ) = {P}_{w} ( t ) - {P}_{g c} ( t ) . \qquad ( 3 )$$

When there is surplus power, the energy management module 113 performs step S660, determining whether the flywheel energy storage device 112 is in a fully charged state according to the SOC of the flywheel energy storage device 112 that is calculated by the flywheel state-of-charge calculation module 114. The SOC is calculated according to equation (4):

$$SOC ( t ) = SO C ( t - 1 ) + \int \frac{{P}_{f ( t )}}{{E}_{f}} dt , \qquad ( 4 )$$

P_{f} refers to output power of the flywheel energy storage device 112, and Ef refers to energy that the flywheel energy storage device 112 can store. If the flywheel energy storage device 112 is not in the fully charged state (SOC<SOCₘₐₓ, where SOCₘₐₓ refers to a maximum charging amount of the flywheel energy storage device 112, which may be set to be 95 percent), the flywheel energy storage device 112 enters a charge mode of step S661, where the surplus power is stored in the flywheel energy storage device 112. If the flywheel energy storage device 112 is in the fully charged state (SOC≥SOCₘₐₓ), the flywheel energy storage device 112 enters a surplus power mode of step S662, where the wave energy generation and flywheel energy storage integration system 110 further uses the power that cannot be stored in the flywheel energy storage device 112 for other uses, such as hydrogen production or resale.

At step S650, as shown in FIG. 7(b), although the wave energy generation device 111 is in the power generation cycle, P_{w}<P_{gc}, that is, the wave energy generation device 111 has insufficient generation power and thus has a requirement for the assistance of the discharge of the flywheel energy storage device 112. Accordingly, step S670 is entered, determining whether the SOC of the flywheel energy storage device 112 is a low state of charge. If so (SOC≤SOCₘᵢₙ, SOCₘᵢₙ refers to a minimum charging amount of the flywheel energy storage device 112, which may be set to be 20 percent), this represents that the rotational kinetic energy of the flywheel of the flywheel energy storage device 112 is also insufficient to supply electrical energy to the grid 120 at this time, and step S674 is then entered, calculating a loss of power supply probability (LPSP). The LPSP is calculated according to equation (5):

$$LPSP = \frac{{Σ}_{t = 1}^{T} {P}_{ins , t}}{{Σ}_{t = 1}^{T} {P}_{g c}} , \qquad ( 5 )$$

P_{ins,t} refers to insufficient power. If power of the flywheel energy storage device 112 is sufficient to be supplied to the grid 120 through discharge (SOC>SOCₘᵢₙ), step S671 is entered, calculating a maximum value E_{FESS,max} of electrical energy that can be released by the flywheel energy storage device 112. The calculation is based on equation (6):

$${E}_{FESS , max} = {E}_{FESS}^{SOC ( t )} - {E}_{FES \overline{S}}^{SOC\_min} = \frac{1}{2} J ( \overline{{ω}_{r}^{2}} - \underline{{ω}_{r}^{2}} ) , \qquad ( 6 )$$

E_{FESS}^{SOC(t)} refers to energy stored in the flywheel energy storage device 112 under the SOC in the time interval t,

$${E}_{FES \overline{S}}^{soc \_ min}$$

refers to energy that should be stored in the flywheel energy storage device 112 under the minimum SOC (SOC_min), J refers to rotational inertia, and ω̅ᵣ̅ and ωᵣ refer to maximum and minimum angular velocities of the rotation of the flywheel 311. Hence, equation (6) is to calculate, according to the rotation speed of the flywheel 311, the amount of rotational kinetic energy of the flywheel of the flywheel energy storage device 112 that can be converted into electrical energy for release.

After calculation is completed, at step S672, whether electrical energy E_{req} that the flywheel energy storage device 112 needs to supply in this time interval t is greater than a maximum value E_{FESS,max} of electrical energy that can be currently released by the flywheel energy storage device 112 is determined, i.e., determining whether a power requirement of the grid 120 reaches a discharge limit of the flywheel energy storage device 112. E_{req} is calculated according to equation (7):

$${E}_{r e q} = \int ( {P}_{g c} - {P}_{w} ) dt . \qquad ( 7 )$$

If E_{req} does not reach the discharge limit of the flywheel energy storage device 112 (E_{req}≤E_{FESS,max}), this represents that the flywheel energy storage device 112 is in an energizable state, with power P_{f} of released electrical energy thereof being sufficient to compensate for the difference between the generation power P_{w} of the wave energy generation device 111 and grid specification power P^{gc}. Accordingly, the flywheel energy storage device 112 is controlled to enter a first discharge mode of step S673. The calculation of power P_{g} output to the grid 120 by the wave energy generation and flywheel energy storage integration system 110, and the relationship between power is according to equation (8), equation (9) and equation (10):

$${P}_{g} ( t ) = {P}_{w} ( t ) - {P}_{f} ( t ) + {P}_{c u r} ( t ) , \qquad ( 8 )$$

$$- {P}_{r e} ( t ) \leq {P}_{g} ( t ) \leq {P}_{w , max} ( t ) , \qquad ( 9 )$$

$$and$$

$${P}_{g c} ( t ) = {P}_{g} ( t ) + {P}_{f} ( t ) , \qquad ( 10 )$$

Pᵣₑ refers to reserve power to be input into the grid 120, and P_{w,max} refers to a maximum generation power of the wave energy generation device 111. If a requirement of the grid 120 reaches a discharge limit of the flywheel energy storage device 112 (E_{req}>E_{FESS,max}), the flywheel energy storage device 112 is enabled to stop discharging upon supplying maximum energy that can be supplied, and the calculation of the loss of power supply probability as in step S674 is performed. The above describes the control of the power mode of the wave energy generation and flywheel energy storage integration system 110 by the energy management module 113 when the wave energy generation device 111 is in the power generation cycle.

As shown in FIG. 7(c), whether or not the wave energy generation device 111 can satisfy the grid specification power during power generation, when the wave energy generation device 111 is in a non-power-generation cycle, i.e., at step S640, the generation power of the wave energy generation device 111 satisfies P_{w}=0, this represents that the wave energy generation device 111 cannot supply power to the grid 120 in this time interval t, and the flywheel energy storage device 112 thus needs to independently release electrical energy to maintain the power supply to the grid 120 by the wave energy generation and flywheel energy storage integration system 110. Accordingly, step S680 is entered, determining whether the SOC of the flywheel energy storage device 112 is the low state of charge. If so (SOC SOCₘᵢₙ), this represents that the rotational kinetic energy of the flywheel of the flywheel energy storage device 112 is also insufficient to supply electrical energy to the grid 120 at this time, and step S684 is then entered, calculating a loss of power supply probability (as equation (5)). If not (SOC>SOCₘᵢₙ), this represents that the flywheel energy storage device 112 can discharge to the grid 120, and step S681 is entered, calculating a maximum value E_{FESS,max} of electrical energy that can be released (as equation (6)). Afterwards, at step S682, whether electrical energy E_{req} that the flywheel energy storage device 112 needs to supply in this time interval t is greater than a maximum value E_{FESS,max} of electrical energy that can be currently released by the flywheel energy storage device 112 is determined, i.e., determining whether a power requirement of the grid 120 reaches a discharge limit of the flywheel energy storage device 112. E_{req} is calculated according to equation (7). If E_{req} does not reach the discharge limit of the flywheel energy storage device 112 (E_{req}≤E_{FESS,max}), this represents that the flywheel energy storage device 112 is in the energizable state, with power P_{f} of released electrical energy thereof being sufficient to satisfy the grid specification power P_{gc} of the grid 120, and accordingly, the flywheel energy storage device 112 is controlled to enter a second discharge mode of step S683. If the requirement of the grid 120 reaches the discharge limit of the flywheel energy storage device 112 (E_{req}>E_{FESS,max}), the flywheel energy storage device 112 is enabled to stop discharging upon supplying maximum energy that can be supplied, and the calculation of the loss of power supply probability as in step S684 is performed. The above describes the control of the power mode of the wave energy generation and flywheel energy storage integration system 110 by the energy management module 113 when the wave energy generation device 111 is in the non-power-generation cycle.

After the determination of this time interval t is completed, and the power mode of the wave energy generation and flywheel energy storage integration system 110 is determined or the calculation of the loss of power supply probability is completed, this time interval t ends, and whether t has reached the assessment time T, i.e., whether t is equal to or greater than T, is determined. If not, step S692 is entered at t=t+1, continuing to start from step S630 to perform determination and control of the next time interval t again until the assessment time T ends (step S691).

By means of the determination process, the energy management module 113 of the wave energy generation and flywheel energy storage integration system 110 controls the wave energy generation and flywheel energy storage integration system 110 to be in the charge mode, the first discharge mode and the second discharge mode, and to enter the surplus power mode when the wave energy generation and flywheel energy storage integration system 110 is sufficient to supply power to the grid 120 and the flywheel energy storage device 112 is also in the fully charged state, so as to redirect the power to other utilizations. Through such mode switching, full use can be made of electrical energy generated by the wave energy generation device 111 in each power generation cycle. In addition, the loss of power supply probability calculated in step S674 and step S684 can be used for monitoring the probability of the loss of power supply of the wave energy generation and flywheel energy storage integration system 110. The loss of power supply probability being 0 in the charge mode, the first discharge mode, the second discharge mode and the surplus power mode indicates that the power supply of the system normally operates. If the loss of power supply probability (LPSP) is greater than 0, this represents that lack of power may occur due to a fault of the system or the grid 120, or other causes.

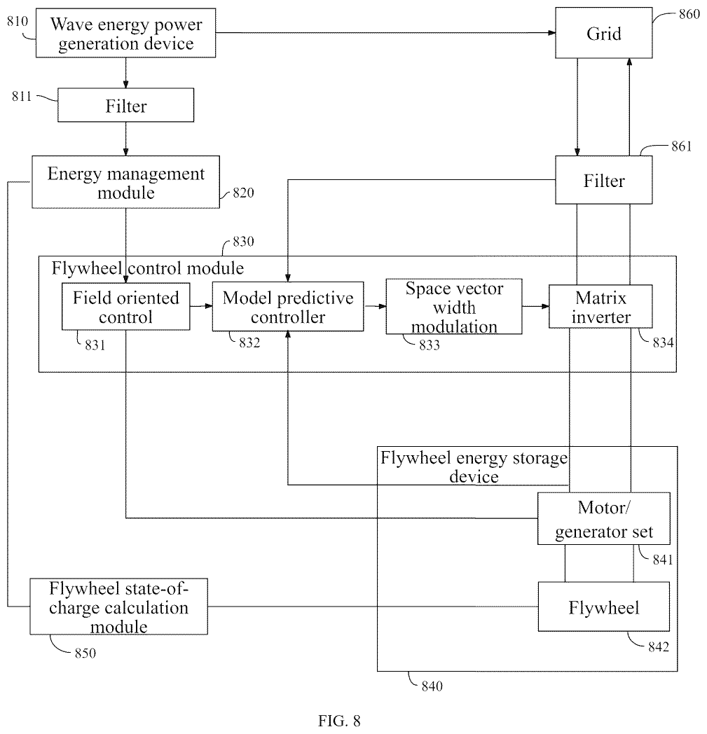

FIG. 8 is a diagram of a control system of a wave energy generation and flywheel energy storage integration system 110 according to an embodiment of the present disclosure. After generating power, a wave energy generation device 810 transmits a power generation state thereof, for example, a voltage signal, to an energy management module 820 through a filter 811. The energy management module 820 performs determination on the basis of the power generation state of the wave energy generation device 810 according to the control and determination process as shown in FIG. 6 and determines a power mode of the wave energy generation and flywheel energy storage integration system 110, and transmits a corresponding control signal, for example, a reference voltage or a rotation speed, to a flywheel control module 830 according to the determined power mode. A field oriented control 831 includes a PI controller and a coordinate system conversion. When a flywheel energy storage device 840 is to be controlled in a charge mode, the field oriented control 831 generates a reference stator current using a control signal provided by the energy management module 820 and the current rotation speed of a motor/generator set 841 of the flywheel energy storage device 840. A stator current of a motor/generator set 312 is predicted by means of a model predictive control 832 according to a reference value and operation states of devices in the wave energy generation and flywheel energy storage integration system 110. An output current and an output power factor of a matrix inverter 834 are then controlled by means of a space vector pulse width modulation 833, so as to obtain a unit power factor. The rotation speed of the motor/generator set 841 is controlled to drive the rotation of a flywheel 842 for energy storage, and at this time, the rotation speed of the flywheel 842 and a SOC are increased. At the same time, a flywheel state-of-charge calculation module 850 calculates and updates a state of charge in real time using the rotation speed of the flywheel 842, such that the energy management module 820 can continuously monitor the state of charge of the flywheel energy storage device 840. When the wave energy generation and flywheel energy storage integration system 110 is in a discharge mode, a voltage of a grid 860, after a filter 861, is transmitted to the model predictive control 832 for prediction, and the matrix inverter 834 is controlled in the same way as that in the charge mode, such that the flywheel 842 drives the motor/generator set 841 to generate power, and the wave energy generation and flywheel energy storage integration system 110 thus meets the requirement of the grid 860 for grid specification power. During discharging, the rotation speed of the flywheel 842 and the SOC are reduced.

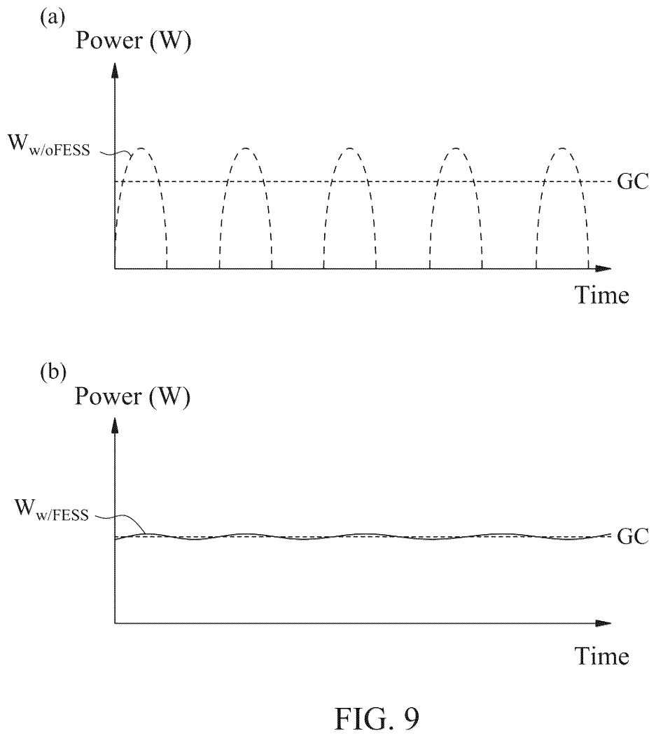

FIG. 9 is a schematic diagram of a comparison of output power of a wave energy generation device 111 and output power of a wave energy generation device integrated with a flywheel energy storage device 112 according to an embodiment of the present disclosure. As shown in FIG. 9(a), when the wave energy generation device 111 is not integrated with the flywheel energy storage device 112, output power W_{w/oFESS} to the grid 120 is intermittent and may not be able to meet the requirement for the grid specification power GC. As shown in FIG. 9(b), the wave energy generation and flywheel energy storage integration system 110 which integrates the wave energy generation device 111 and the flywheel energy storage device 112 stably supplies output power W_{w/FESS} to the grid 120, and can continuously conform to the grid specification power GC.

Although the present disclosure has been disclosed above with the embodiments, the embodiments are not intended to limit the present disclosure, any skilled in the art can make some variations and modifications without departing from the spirit and scope of the present disclosure, and therefore, the scope of protection of the present disclosure shall be defined by the claims.

What is claimed is:

1. A wave energy generation and flywheel energy storage integration system, comprising:
a wave energy generation device, which is configured to convert wave energy into electrical energy in a power generation cycle, and supply the electrical energy to a grid;
a flywheel energy storage device, which is configured to store rotational kinetic energy of a flywheel;
a flywheel state-of-charge calculation module, which is configured to calculate the rotational kinetic energy of the flywheel to obtain a calculation result; and
an energy management module, which is configured to determine whether the flywheel energy storage device is in a fully charged state and in an energizable state according to the calculation result, when the wave energy generation device is in the power generation cycle, power of the electrical energy does not satisfy grid specification power of the grid and the flywheel energy storage device is in the energizable state, control the flywheel energy storage device to release the rotational kinetic energy of the flywheel for compensating and outputting power, so as to stably supply power to the grid, and when the flywheel energy storage device is not in the energizable state, calculate a loss of power supply probability of the wave energy generation and flywheel energy storage integration system.

2. The wave energy generation and flywheel energy storage integration system according to claim 1, wherein when the wave energy generation device is in the power generation cycle, the power exceeds the grid specification power and the flywheel energy storage device is not in the fully charged state, the energy management module controls the flywheel energy storage device to receive a remaining part of power of the electrical energy to charge the flywheel energy storage device, so as to increase the rotational kinetic energy of the flywheel.

3. The wave energy generation and flywheel energy storage integration system according to claim 1, wherein when the wave energy generation device is not in the power generation cycle and the flywheel energy storage device is in the energizable state, the energy management module is further configured to control the flywheel energy storage device to release the rotational kinetic energy of the flywheel, so as to continuously output power to stably supply power to the grid.

4. The wave energy generation and flywheel energy storage integration system according to claim 1, wherein the wave energy generation device comprises:
a wave energy collection unit, which is configured to collect wave energy, wherein the wave energy collection unit comprises a channel, which is built by two adjacent guide walls, has a wave inlet and a wave outlet, and has a collection angle, and
the magnitude of wave energy which is collected by the wave energy collection unit is adjusted according to the length of the two guide walls and the collection angle.

5. The wave energy generation and flywheel energy storage integration system according to claim 4, wherein the two guide walls are made of a carbon-negative material.

6. A wave energy generation and flywheel energy storage integration method, comprising:
converting, by means of a wave energy generation device, wave energy into electrical energy in a power generation cycle, and supplying the electrical energy to a grid;
storing rotational kinetic energy of a flywheel by means of a flywheel energy storage device;
calculating the rotational kinetic energy of the flywheel to obtain a calculation result;
determining, according to the calculation result, whether a flywheel energy storage device is in a fully charged state and in an energizable state;
when the wave energy generation device is in the power generation cycle, power of the electrical energy does not satisfy grid specification power of the grid and the flywheel energy storage device is in the energizable state, controlling the flywheel energy storage device to release the rotational kinetic energy of the flywheel for compensating and outputting power, so as to stably supply power to the grid; and
when the flywheel energy storage device is not in the energizable state, calculating a loss of power supply probability of a wave energy generation and flywheel energy storage integration system composed of the wave energy generation device and the flywheel energy storage device.

7. The wave energy generation and flywheel energy storage integration method according to claim 6, wherein when the wave energy generation device is in the power generation cycle, the power exceeds the grid specification power and the flywheel energy storage device is not in the fully charged state, the flywheel energy storage device is controlled to receive a remaining part of power of the electrical energy to charge the flywheel energy storage device, so as to increase the rotational kinetic energy of the flywheel.

8. The wave energy generation and flywheel energy storage integration method according to claim 6, wherein when the wave energy generation device is not in the power generation cycle and the flywheel energy storage device is in the energizable state, the flywheel energy storage device is controlled to release the rotational kinetic energy of the flywheel, so as to continuously output power to stably supply power to the grid.

9. The wave energy generation and flywheel energy storage integration method according to claim 6, further comprising:
adjusting the magnitude of wave energy which is collected by the wave energy collection unit using the length of two adjacent guide walls which form a channel of the wave energy collection unit in the wave energy generation device, and a collection angle of the channel.

10. The wave energy generation and flywheel energy storage integration method according to claim 9, further comprising:
performing carbon capture and carbon curing using a carbon-negative material which is contained in the two guide walls.
